(19) United States
(12) Patent Application Publication
(10) Pub. No.: US 2007/0086627 A1
(43) Pub. Date: Apr. 19, 2007

(54) Face identification apparatus, medium, and method

(75) Inventor: Taekyun Kim, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/251,769

(22) Filed: Oct. 18, 2005

(51) Int. Cl. G06K 9/00

(52) U.S. Cl. 382/118

(57) ABSTRACT

A face identification apparatus, medium, and method. The face identification apparatus may include a plurality of face identification units, which are independent from each other, each of the face identification units calculating a confidence based on a similarity between a rotated face image and a frontal face image, and a confidence combination unit, which combines the confidences provided from the plurality of face identification units.

### BACKGROUND OF THE INVENTION

1. Field of the Invention

Embodiments of the present invention relate to face identification, and more particularly, to a face identification apparatus, medium, and method enhancing the precision of face identification regardless of view variations.

2. Description of the Related Art

Face recognition, which is an application field for face identification technologies, has been widely used for various identification purposes because of its user-friendly characteristics, even though it is considered less precise than fingerprint recognition or iris recognition. One of the biggest advantages of face recognition is that a face recognition system can almost unconsciously, e.g., automatically, recognize people faces, even from a distance. However, face recognition systems may not be able to precisely recognize people's faces when receiving non-frontal face images. Therefore, in order to guarantee superior face recognition capability of the face recognition system, a considerable number of face images, taken from as many views as possible under various conditions should be gathered, and a training face image database (DB) of those face images should be constructed. However, it is difficult to obtain an arbitrary person's face images with such various poses.

Thus, there is a need for a face identification operation that can improve the precision of face identification regardless of view variations.

### SUMMARY OF THE INVENTION

Embodiments of the present invention set forth a face identification apparatus, medium, and method that can improve the precision of face identification regardless of view variations.

To achieve the above and/or other aspects and advantages, embodiments of the present invention includes a face identification apparatus, including a plurality of independent face identification units, with each of the face identification units generating a confidence based on a similarity between a rotated face image and a frontal face image, and a confidence combination unit to combine confidences generated by the plurality of face identification units.

The plurality of face identification units may include a first face identification unit, to transform a view of the rotated face image into a frontal image view, and to calculate a first confidence between feature vectors of the frontal face image and feature vectors of the view-transformed rotated face image corresponding to the frontal image view, and a second face identification unit to obtain feature vectors of the rotated face image and feature vectors of the frontal face image using a view-specific local linear transformation function and to calculate a second confidence between the linear transformation function obtained feature vectors of the rotated face image and the linear transformation function obtained feature vectors of the frontal face image.

The first face identification unit may include a subspace transformation unit to transform the rotated face image and the frontal face image on a subspace using a subspace transformation function, a view transformation unit to transform a view of the subspace transformed rotated face image into the frontal view, using a view transformation function, and a discrimination unit to obtain the feature vectors of the view-transformed rotated face image and the feature vectors of the frontal face image using a discrimination function to calculate the first confidence.

The first face identification unit may further include a training unit to analyze training face images to generate the subspace transformation function, the view transformation function, and the discrimination function.

The second face identification unit may include a training unit to analyze training face images to generate the view-specific local linear transformation function, and a discrimination unit to obtain the obtained feature vectors of the rotated face image and the obtained feature vectors of the frontal face image using the view-specific local linear transformation function to calculate the second confidence.

The plurality of face identification units may include a third face identification unit to obtain feature vectors of the rotated face image and feature vectors of the frontal face image using a kernel discrimination function and to calculate a third confidence between the kernel discrimination function based feature vectors of the rotated face image and the kernel discrimination function based feature vectors of the frontal face image.

The third face identification unit may further include a training unit to analyze training face images to generate the kernel discrimination function, and a discrimination unit, which obtains the kernel discrimination function based feature vectors of the rotated face image and the kernel discrimination function based feature vectors of the frontal face image, using a kernel discrimination function, to calculate the third confidence.

The plurality of face identification units may further include a fourth face identification unit to transform a view of the frontal face image into a rotated face image view, to obtain feature vectors of the rotated face image and feature vectors of the view-transformed frontal face image, and to calculate a fourth confidence between the fourth face identification unit obtained feature vectors of the rotated face image and the fourth face identification unit obtained feature vectors of the view-transformed frontal face image.

The fourth face identification unit may include an average lookup table database, which is a database of view-specific average lookup tables obtained by rotating a plurality of three-dimensional face models by a predetermined angle, generating a plurality of two-dimensional face images having a predetermined view, and averaging coordinates of correspondence points between the two-dimensional face images and the respective frontal face images, a view transformation unit to transform the frontal face image into the rotated face image view with reference to the view-specific average lookup tables, and discrimination unit to obtain the fourth face identification unit obtained feature vectors of the view-transformed rotated face image and the fourth face identification unit obtained feature vectors of the frontal face image using a discrimination function to calculate the fourth confidence.

The fourth face identification unit may further include a training unit to analyze training face images with reference to the view-specific average lookup tables to generate the discrimination function.

The plurality of face identification units may still further include a third face identification unit to transform a view of the frontal face image into a rotated face image view, to obtain feature vectors of the rotated face image and feature vectors of the view-transformed frontal face image, and to calculate a third confidence between the third face identification unit obtained feature vectors of the rotated face image and the third face identification unit obtained feature vectors of the view-transformed frontal face image.

Further, the plurality of face identification units may include a first face identification unit to transform a view of the rotated face image into a frontal face image view, and to calculate a first confidence between feature vectors of the frontal face image and feature vectors of the view-transformed rotated face image corresponding to the frontal face image, and a second face identification unit to obtain feature vectors of the rotated face image and feature vectors of the frontal face image using a kernel discrimination function and to calculate a second confidence between the kernel discrimination function based feature vectors of the rotated face image and the kernel discrimination function based feature vectors of the frontal face image.

The plurality of face identification units may further include a third face identification unit to transform a view of the frontal face image into a rotated face image view, to obtain feature vectors of the rotated face image and feature vectors of the view-transformed frontal face image, and to calculate a third confidence between the third face identification unit obtained feature vectors of the rotated face image and the third face identification unit obtained feature vectors of the view-transformed frontal face image.

In addition, the plurality of face identification units may include a first face identification unit to transform a view of the rotated face image into a frontal face image view, and to calculate a first confidence between feature vectors of the frontal face image and feature vectors of the view-transformed rotated face image corresponding to the frontal face image, and a second face identification unit to transform a view of the frontal face image into a rotated face image view, to obtain the feature vectors of the rotated face image and feature vectors of the view-transformed frontal face image, and to calculate a second confidence between the obtained feature vectors of the rotated face image and the obtained feature vectors of the view-transformed frontal face image.

Still further, the plurality of face identification units may include a first face identification unit to obtain feature vectors of the rotated face image and feature vectors of the frontal face image using a view-specific local linear transformation function and to calculate a first confidence between the specific local linear transformation function based feature vectors of the rotated face image and the specific local linear transformation function based feature vectors of the frontal face image, and a second face identification unit to obtain feature vectors of the rotated face image and feature vectors of the frontal face image using a kernel discrimination function and to calculate a second confidence between the kernel discrimination function based feature vectors of the rotated face image and the kernel discrimination function based feature vectors of the frontal face image.

The plurality of face identification units further may include a third face identification unit to transform a view of the frontal face image into a rotated face image view, to obtain feature vectors of the rotated face image and feature vectors of the view-transformed frontal face image, and to calculate a third confidence between the third face identification obtained feature vectors of the rotated face image and the third face identification obtained feature vectors of the view-transformed frontal face image.

In addition, plurality of face identification units may include a first face identification unit to obtain feature vectors of the rotated face image and feature vectors of the frontal face image using a view-specific local linear transformation function and to calculate a first confidence between the local linear transformation function based feature vectors of the rotated face image and the local linear transformation function based feature vectors of the frontal face image, and a second face identification unit to transform a view of the frontal face image into a rotated face image view, to obtain feature vectors of the rotated face image and feature vectors of the view-transformed frontal face image, and to calculate a second confidence between the second face identification unit obtained feature vectors of the rotated face image and the second face identification unit obtained feature vectors of the view-transformed frontal face image.

The plurality of face identification units may include a first face identification unit to obtain feature vectors of the rotated face image and feature vectors of the frontal face image using a kernel discrimination function and to calculate a first confidence between the kernel discrimination function based feature vectors of the rotated face image and the kernel discrimination function based feature vectors of the frontal face image, and a second face identification unit to transform a view of the frontal face image into a rotated face image view, to obtain feature vectors of the rotated face image and feature vectors of the view-transformed frontal face image, and to calculate a second confidence between the second face identification unit obtained feature vectors of the rotated face image and the second face identification unit obtained feature vectors of the view-transformed frontal face image.

The confidence combination unit may combine the confidences generated by the plurality of face identification units using any one of an addition operation, a product operation, a maximum selection operation, a minimum selection operation, a median selection operation, and a weighted summation operation to perform the combination.

To achieve the above and/or other aspects and advantages, embodiments of the present invention includes a face identification apparatus, including a subspace transformation unit to transform a rotated face image and a frontal face image on a subspace using a subspace transformation function, a view transformation unit to transform a view of the subspace transformed rotated face image into a frontal view using a view transformation function, and a discrimination unit to obtain feature vectors of the view-transformed rotated face image and feature vectors of the frontal face image using a discrimination function to calculate a confidence based on a similarity between the view-transformed rotated face image and the frontal face image.

The face identification may further include a training unit, to analyze training face images to generate the subspace transformation function, the view transformation function, and the discrimination function.

To achieve the above and/or other aspects and advantages, embodiments of the present invention includes a face identification apparatus including an average lookup table database, which is a database of view-specific average lookup tables-obtained by rotating a plurality of three-dimensional face models by a predetermined angle, generating a plurality of two-dimensional face images having a predetermined view, and averaging coordinates of correspondence points between the two-dimensional face images and the respective frontal face images, a view transformation unit to transform a view of a frontal face image into a rotated face image view with reference to the view-specific average lookup tables, and a discrimination unit to obtain feature vectors of the view-transformed rotated face image and feature vectors of the frontal face image using a discrimination function to calculate a confidence based on a similarity between the view-transformed rotated face image and the frontal face image.

The face identification apparatus may further include a training unit to analyze training face images with reference to the view-specific average lookup tables to generate the discrimination function.

To achieve the above and/or other aspects and advantages, embodiments of the present invention includes a face identification apparatus, including a plurality of independent face identification units, with each of the face identification units generating a confidence based on a similarity between a rotated face image and a frontal face image, and a confidence combination unit to combine confidences generated from the plurality of face identification units, wherein the plurality of face identification units include at least two face identification units among: a first face identification unit to transform a view of the rotated face image into a frontal image view, and to calculate a first confidence between feature vectors of the frontal face image and feature vectors of the view-transformed rotated face image corresponding to the frontal view, a second face identification unit to obtain feature vectors of the rotated face image and feature vectors of the frontal face image using a view-specific local linear transformation function and to calculate a second confidence between the local linear transformation function based feature vectors of the rotated face image and the local linear transformation function based feature vectors of the frontal face image, a third face identification unit to obtain feature vectors of the rotated face image and feature vectors of the frontal face image using a kernel discrimination function and to calculate a third confidence between the kernel discrimination function based feature vectors of the rotated face image and the kernel discrimination function based feature vectors of the frontal face image, and a fourth face identification unit to transform a view of the frontal face image into a rotated face image view, to obtain feature vectors of the rotated face image and feature vectors of the view-transformed frontal face image, and to calculates a fourth confidence between the fourth face identification unit obtained feature vectors of the rotated face image and the fourth face identification unit obtained feature vectors of the view-transformed frontal face image.

To achieve the above and/or other aspects and advantages, embodiments of the present invention includes a face identification method, including transforming a view of a rotated face image into a frontal image view, and calculating a first confidence between feature vectors of a frontal face image and feature vectors of the view-transformed rotated face image, obtaining feature vectors of the rotated face image and feature vectors of the frontal face image using a view-specific local linear transformation function and calculating a second confidence between the obtained feature vectors of the rotated face image and the obtained feature vectors of the frontal face image, and combining at least the first and second confidences.

In the combining of the at least first and second confidences, the at least first and second confidences may be combined using any one of an addition operation, a product operation, a maximum selection operation, a minimum selection operation, a median selection operation, and a weighted summation operation.

The method may further include obtaining feature vectors of the rotated face image and feature vectors of the frontal face image using a kernel discrimination function and calculating a third confidence between the kernel discrimination function based feature vectors of the rotated face image and the kernel discrimination function based feature vectors of the frontal face image.

In addition, the method may include transforming a view of the frontal face image into a rotated face image view, obtaining feature vectors of the rotated face image and feature vectors of a view-transformed frontal face image, and calculating a fourth confidence between feature vectors of the rotated face image and the obtained feature vectors of the view-transformed frontal face image.

Still further, the method may include transforming a view of the frontal face image into a rotated face image view, obtaining feature vectors of the rotated face image and feature vectors of a view-transformed frontal face image, and calculating a third confidence between feature vectors of the rotated face image and the obtained feature vectors of the view-transformed frontal face image.

To achieve the above and/or other aspects and advantages, embodiments of the present invention includes a face identification method, including transforming a view of a rotated face image into a frontal image view, and calculating a first confidence between feature vectors of a frontal face image and feature vectors of the view-transformed rotated face image, obtaining feature vectors of the rotated face image and feature vectors of the frontal face image using a kernel discrimination function and calculating a second confidence between the obtained feature vectors of the rotated face image and the obtained feature vectors of the frontal face image, and combining at least the first and second confidences.

In the combining the at least first and second confidences, the at least first and second confidences may be combined using any one of an addition operation, a product operation, a maximum selection operation, a minimum selection operation, a median selection operation, and a weighted summation operation.

The method may further include transforming a view of the frontal face image into a rotated face image view, obtaining feature vectors of the rotated face image and feature vectors of the view-transformed frontal face image, and calculating a third confidence between feature vectors of the rotated face image and the obtained feature vectors of the view-transformed frontal face image.

To achieve the above and/or other aspects and advantages, embodiments of the present invention includes a face identification method including transforming a view of a rotated face image into a frontal image view, and calculating a first confidence between feature vectors of a frontal face image and feature vectors of the view-transformed rotated face image, transforming a view of the frontal face image into a rotated face image view, obtaining feature vectors of the rotated face image and feature vectors of a view-transformed frontal face image, and calculating a third confidence between obtained feature vectors of the rotated face image and the obtained feature vectors of the view-transformed frontal face image, and combining a at least the first and second confidences.

In the combining of the at least first and second confidences, the at least first and second confidences may be combined using any one of an addition operation, a product operation, a maximum selection operation, a minimum selection operation, a median selection operation, and a weighted summation operation.

To achieve the above and/or other aspects and advantages, embodiments of the present invention includes a face identification method, including obtaining feature vectors of a rotated face image and feature vectors of a frontal face image using a view-specific local linear transformation function and calculating a first confidence between the local linear transformation function based feature vectors of the rotated face image and the local linear transformation function based feature vectors of the frontal face image, obtaining feature vectors of the rotated face image and feature vectors of the frontal face image using a kernel discrimination function and calculating a second confidence between the kernel discrimination function based feature vectors of the rotated face image and the kernel discrimination function based feature vectors of the frontal face image, and combining at least the first and second confidences.

In the combining of the at least first and second confidences, the first and second confidences may be combined using any one of an addition operation, a product operation, a maximum selection operation, a minimum selection operation, a median selection operation, and a weighted summation operation.

The method may further include transforming a view of the frontal face image into a rotated face image view, obtaining feature vectors of the rotated face image and feature vectors of the view-transformed frontal face image, and calculating a third confidence between feature vectors of the rotated face image and the obtained feature vectors of the view-transformed frontal face image.

To achieve the above and/or other aspects and advantages, embodiments of the present invention includes a face identification method, including obtaining feature vectors of a rotated face image and feature vectors of a frontal face image using a view-specific local linear transformation function and calculating a first confidence between the linear transformation function based feature vectors of the rotated face image and the linear transformation function based feature vectors of the frontal face image, transforming a view of the frontal face image into a rotated face image view, obtaining feature vectors of the rotated face image and feature vectors of the view-transformed frontal face image, and calculating a second confidence between feature vectors of the rotated face image and the obtained feature vectors of the view-transformed frontal face image, and combining at least the first and second confidences.

In the combining of the first and second confidences, the first and second confidences may be combined using any one of an addition operation, a product operation, a maximum selection operation, a minimum selection operation, a median selection operation, and a weighted summation operation.

To achieve the above and/or other aspects and advantages, embodiments of the present invention includes a face identification method, including transforming a view of a rotated face image into a frontal image view, and calculating a first confidence between feature vectors of a frontal face image and feature vectors of the view-transformed rotated face image, obtaining feature vectors of the rotated face image and feature vectors of the frontal face image using a view-specific local linear transformation function and calculating a second confidence between the local linear transformation function based feature vectors of the rotated face image and the local linear transformation function based feature vectors of the frontal face image, obtaining feature vectors of the rotated face image and feature vectors of the frontal face image using a kernel discrimination function and calculating a third confidence between the a kernel discrimination function based feature vectors of the rotated face image and the a kernel discrimination function based feature vectors of the frontal face image, transforming a view of the frontal face image into a rotated face image view, obtaining feature vectors of the rotated face image and feature vectors of the view-transformed frontal face image, and calculating a fourth confidence between feature vectors of the rotated face image and the obtained feature vectors of the view-transformed frontal face image, and combining at least two confidences among the first, second, third, and fourth confidences.

To achieve the above and/or other aspects and advantages, embodiments of the present invention includes a medium including computer readable code to implement a face identification method including transforming a view of a rotated face image into a frontal image view, and calculating a first confidence between feature vectors of a frontal face image and feature vectors of the view-transformed rotated face image, obtaining feature vectors of the rotated face image and feature vectors of the frontal face image using a view-specific local linear transformation function and calculating a second confidence between the linear transformation function based feature vectors of the linear transformation function rotated face image and the linear transformation function based feature vectors of the frontal face image, obtaining feature vectors of the rotated face image and feature vectors of the frontal face image using a kernel discrimination function and calculating a third confidence between the kernel discrimination function based feature vectors of the rotated face image and the kernel discrimination function based feature vectors of the frontal face image, transforming a view of the frontal face image into a rotated face image view, obtaining feature vectors of the rotated face image and feature vectors of the view-transformed frontal face image, and calculating a fourth confidence between feature vectors of the rotated face image and the obtained feature vectors of the view-transformed frontal face image, and combining at least two confidences among the first, second, third, and fourth confidences.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a face identification apparatus, according to an embodiment of the present invention;

FIG. 2 illustrates a first face identification unit, such as that of FIG. 1, according to an embodiment of the present invention;

FIG. 3 illustrates various results of a view transformation operation performed by a first view transformation unit, such as that of FIG. 2, according to an embodiment of the present invention;

FIG. 4 illustrates a second face identification unit, such as that of FIG. 1, according to an embodiment of the present invention;

FIG. 5 illustrates the operation of the second face identification unit, such as that of FIG. 4, according to an embodiment of the present invention;

FIG. 6 illustrates a third face identification unit, such as that of FIG. 1, according to an embodiment of the present invention;

FIG. 7 illustrates a fourth face identification unit, such as that of FIG. 1, according to an embodiment of the present invention;

FIG. 8 illustrates the generating of an average lookup table DB of FIG. 7, according to an embodiment of the present invention;

FIG. 9 illustrates various results of a view transformation operation performed by a second view transformation unit, such as that of FIG. 7, according to an embodiment of the present invention;

FIGS. 10A and 10B illustrating examples of a DB used for testing a performance of a face identification apparatus, according to an embodiment of the present invention;

FIG. 11A illustrates a comparison of face recognition rates of first, second, third, and fourth face identification units, such as that of FIG. 1, when dealing with rotated face images taken in a first session, according to an embodiment of the present invention;

FIG. 11B illustrates a comparison of face recognition rates of first, second, third, and fourth face identification units, such as that of FIG. 1, when dealing with frontal and rotated face images taken in a second session, according to an embodiment of the present invention;

FIG. 12A illustrates a comparison of face recognition rates obtained using various combination methods to deal with rotated face images taken in a first session, according to an embodiment of the present invention;

FIG. 12B illustrates a comparison of face recognition rates obtained using various combination methods to deal with frontal and rotated face images taken in a second session, according to an embodiment of the present invention; and

FIG. 13 illustrates a comparison of face recognition rates obtained using different numbers of face identification units, according to embodiments of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

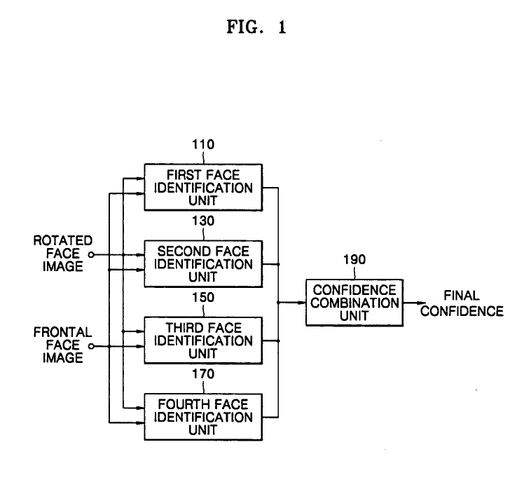

FIG. 1 illustrates a face identification apparatus, according to an embodiment of the present invention. Referring to FIG. 1, the face identification apparatus may include first, second, third, and fourth face identification units 110, 130, 150, and 170 and a confidence combination unit 190, for example. Here, in FIG. 1, the face identification apparatus has been illustrated as having four face identification units. However, the face identification apparatus may have at least two face identification units, as long as the face identification units are independent of each other.

Referring to FIG. 1, the first, second, third, and fourth face identification units 110, 130, 150, and 170 may generate first, second, third, and fourth confidences, respectively, between frontal and non-frontal (rotated) face images and provide the first, second, third, and fourth confidences to the confidence combination unit 190. Here, the non-frontal face images will be referred to as rotated face images, as they may be non-frontal versions of the frontal face images. Each of the first, second, third, and fourth confidences represents a similarity between a frontal face image and a rotated face image. Here, the rotated face image may be an input face image that is subjected to face recognition, face authentication, or face retrieval, for example, and the frontal face image may be any of a plurality of face images, e.g., images registered in the face identification apparatus. If the input face image is a frontal face image, the input face image may not be subjected to view transformation operations, as may be performed by the first and fourth face identification units 110 and 170. Here, it will be hereinafter assumed that a view of a rotated face image is an already estimated face image using various view estimation methods.

The first face identification unit 110 may receive vectors of a rotated face image and vectors of a frontal face image and represent the vectors of the rotated face image and the frontal face image on a subspace, e.g., using a subspace transformation function. The first face identification unit 110 may transform a view of the vectors of the rotated face, represented on the subspace, into a frontal view. Thereafter, the first face identification unit 110 may determine a first confidence between vectors of the view-transformed rotated face image and vectors of the frontal face image using a first discrimination function, for example. Here, any of the subspace transformation function, view transformation function, and first discrimination function may be generated in advance, e.g., by computational learning using Principal Component Analysis (PCA), Linear Matrix, and Linear Discriminant Analysis (LDA) methods, respectively.

The second face identification unit 130 may determine a second confidence between vectors of a rotated face image and vectors of a frontal face image using a second discrimination function, for example. Here, the second discrimination function may be generated in advance, e.g., by computational learning using a Locally Linear Discriminant Analysis (LLDA) method.

The third face identification unit 150 may determine a third confidence between vectors of a rotated face image and vectors of a frontal face image-using a third discrimination function, for example. Here, the third discrimination function may be generated in advance, e.g., by computational learning using a generalized discriminant analysis (GDA) method.

The fourth face identification unit 170 may receive vectors of a rotated face image and vectors of a frontal face image and transform a view of vectors of the frontal face image to correspond, e.g., be the same, as a view of vectors of the rotated face image, e.g., with reference to an average lookup table. Thereafter, the fourth face identification unit 170 may determine a fourth confidence between the vectors of the rotated face image and the vectors of the view-transformed frontal face image using a fourth discrimination function, for example. Here, the fourth discrimination function may be generated in advance, e.g., by computational learning using the LDA method.

The confidence combination unit 190 may combine first, second, third, and fourth confidences, for example, provided by the respective first, second, third, and fourth face identification units 110, 130, 150, and 170, and thereby generate a final confidence. When combining the first, second, third, and fourth confidences, the confidence combination unit 190 may use a predetermined combination operation, such as product (prod), summation (sum), maximum selection (max), minimum selection (min), median selection (median), or weighted summation (weight-sum), which will be described in the following in detail, noting that embodiments of the present invention are not limited thereto.

A confidence Cᵢⱼ(x) of one (j) of a corresponding face identification unit 110, 130, 150, and 170, for a predetermined class (i), may be expressed as a normalized Euclidean distance between output vectors of a rotated face image and output vectors of a frontal face image. The confidence Cᵢⱼ(x) can be scaled to have a value between 0 and 1, for example.

As noted above, final confidence Qⱼ(x) (i=1, . . . , c) may be defined through any of product (prod), summation (sum), maximum selection (max), minimum selection (min), median selection (median), and weighted summation (weight-sum), for example, as set forth below in Equations 1-6.

$$\begin{matrix}{Q}_{i} = {\prod }_{i} {C}_{ij} ( x ) & ( 1 ) \\ {Q}_{i} = {\sum }_{j} {C}_{ij} ( x ) & ( 2 ) \\ {Q}_{i} = {max}_{j} {C}_{ij} ( x ) & ( 3 ) \\ {Q}_{i} = {min}_{j} {C}_{ij} ( x ) & ( 4 ) \\ {Q}_{i} = {median }_{j} {C}_{ij} ( x ) & ( 5 ) \\ {Q}_{i} = {\sum }_{j} {w}_{j} {C}_{ij} ( x ) & ( 6 )\end{matrix}$$

Here, in Equation (6), wⱼ may be a weight value determined, in advance, in consideration of known performance of each of the first, second, third, and fourth face identification units 110, 130, 150, and 170, for example.

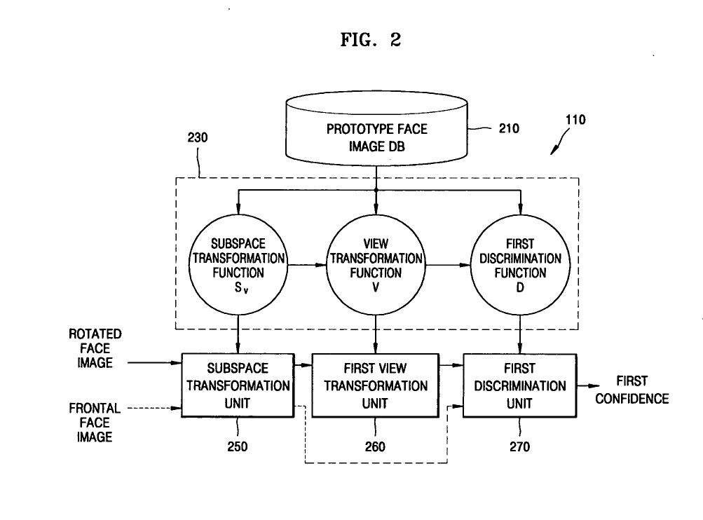

If the number of training face images included in a prototype face image DB (e.g., DB 210 of FIG. 2) is sufficiently large and evaluation sets of face images are provided separately from the training face images, conventional combination operations, other than those defined in Equations (1) through (6), may be applied to the combination of the first, second, third, and fourth confidences. In addition, any type of face identification units, other than the first, second, third, and fourth face identification units 110, 130, 150, and 170, may be alternately, or in addition, used as long as they serve similar accomplishments to those of the first, second, third, and fourth face identification units 110, 130, 150, and 170, for example, and respectively output confidences that are independent from one another.

FIG. 2 illustrates a first face identification unit, such as the first face identification unit 110 of FIG. 1. Referring to FIG. 2, the first face identification unit 110 may include the prototype face image DB 210, a training unit 230, a subspace transformation unit 250, a first view transformation unit 260, and a first discrimination unit 270, for example.

The prototype face image DB 210 may be a database of frontal face images and rotated versions of the frontal face images, having various views.

The training unit 230 may generate a subspace transformation function Sᵥ, corresponding to the view v, in advance, by performing a computational leaning using PCA on frontal face images, which may be two-dimensional, and respective rotated face images within the predetermined range of the view v. The frontal face images and the respective rotated face images may all be stored in the prototype face image DB 210. Thereafter, the training unit 230 may generate a view transformation function V, which can be used for transforming vectors of each of the rotated face images that are projected onto a view subspace, by the subspace transformation function Sᵥ, to have a frontal view. Thereafter, the training unit 230 may generate a first discrimination function D through computational leaning using LDA. The first discrimination function D may be used for determining the first confidence between frontal face images stored in the prototype face image database 210 and respective view-transformed rotated face images.

The subspace transformation unit 250 may receive vectors of a frontal face image and vectors of a rotated version of the frontal face image and project vectors of the rotated face image and vectors of the frontal face image onto a view subspace, e.g., using the subspace transformation function Sᵥ, as defined by Equation (7) below. The subspace transformation function Sᵥ may be generated by performing PCA on a set of training face images in the prototype face image DB 210, for example.
b_{v,i}=Sᵥ(x_{v,i},avgᵥ) (7)

In Equation (7), x_{v,i} may be an i-th face among a set of training face images, within a predetermined range of the view v, avgᵥ may be the local mean of the training face images, within the predetermined range of the view v, b_{v,i} may be a face image obtained by projecting xᵥᵢ onto a subspace, and Sᵥ may be a subspace transformation function for projecting the face images, within the predetermined view v, onto the subspace.

The generation of the subspace transformation function Sᵥ, through PCA, will be described below in greater detail.

An eigenspace may be established using a covariance matrix of training face images stored in the prototype face image DB 210, and a plurality of eigenvectors corresponding to various image sizes may be generated, e.g., P_{M}=[p₁, . . . , p_{M}] where P_{M} is a set of M eigenvectors respectively corresponding to M maximum eigenvalues. Face images projected onto a subspace, using Equation (7), may be defined by the below Equations (8) and (9) using view-specific eigenvectors, i.e., an eigenvector P^{T}_{f,M} corresponding to a frontal view f and an eigenvector P^{T}_{r,M} corresponding to a rotated view r.
b_{f,i}=P^{T}_{f,M}·(x_{f,i}−avg_{f}) (8)
b_{r,i}=P^{T}_{r,M}·(x_{r,i}−avgᵣ) (9)

Here, x_{f,i} may be an i-th face image among a set of training face images having a frontal view f, x_{r,i} may be an i-th face image of a set of training face images having a predetermined range of a rotated view r, avg_{f} may be a local mean of the training face images having the frontal view f, avgᵣ may be the local mean of the training face images having the predetermined range of the rotated view r, b_{f,i} may be a face image obtained by projecting x_{f,i} onto a subspace, and b_{r,i} may be a face image obtained by projecting x_{r,i} onto the subspace. B_{f}={b_{f,1},b_{f,2}, . . . ,b_{f,N}}, and Bᵣ={b_{r,1},b_{r,2}, . . . ,b_{r,N}} where N is a total number of training face images having the frontal view f or the rotated view r.

The first view transformation unit 260 may transform a view of a rotated face image from a rotated view r to a frontal view f using a view transformation function V, e.g., as referenced below in Equation (10), and may be generated by computational learning to satisfy a least square error (LSE) condition:

$$V = {min}_{arg V} {\sum }_{i = 1}^{N} {\vert {b}_{f , i} - V ( {b}_{r , i} ) \vert}^{2} \qquad ( 10 )$$

Here, b_{f,i} may be a face image obtained by projecting an i-th frontal face image x_{f,i} onto a subspace, b_{r,i} may be a face image obtained by projecting an i-th rotated face image x_{r,i} onto the subspace, and V(b_{r,i}) may be a view transformation function for transforming b_{r,i} to have the frontal view f.

The view transformation function V(b_{r,i}) may be generated using a linear matrix or a neural network, for example. The generation of the view transformation function V(b_{r,i}) using a linear matrix will be described in greater detail below.

An M×M linear matrix LM that satisfies B_{f}=LM·Bᵣ can be obtained. An i-th element B_{fij} of a j-th feature vector B_{fj} can further be obtained, for example, by the below Equation (11):
b_{fij}=LMᵢ₁Bᵣ₁ⱼ+ . . . +LM_{iM}B_{rMj} (11)

A total of N equations for obtaining M unknown parameters LMᵢ₁, . . . , LM_{iM} can be obtained using Equation (11). M×M unknown parameters of the linear matrix LM can be determined based on N×M known values. The linear matrix LM may also be obtained, for example, by below Equation (12), which may be obtained by substituting LM for V of Equation (10).

$$LM = {min}_{arg LM} {\sum }_{i = 1}^{N} {\vert {b}_{f , i} - LM ( {b}_{r , i} ) \vert}^{2} \qquad ( 12 )$$

The linear matrix LM may also be defined by below Equation (13):
LM=B_{f}Bᵣ^{T}(BᵣBᵣ^{T})⁻¹ (13)

A face image X′_{f}, whose view has been transformed into the frontal view f, by the linear matrix LM, may be expressed by the following equation: X′_{f}=P_{f,M}(LM·Bᵣ)+avg_{f}.

The first discrimination unit 270 may generate the first confidence between the view-transformed rotated face image and the frontal face image using the first discrimination function D. To do this, the training unit 230 may generate the first discrimination function D, in advance, functionally mapping the frontal face image and the view-transformed rotated face image to a feature vector d_{f,i} and a feature vector d_{r,i}, respectively. The feature vectors d_{f,i} and d_{r,i} may be expressed by below Equation (14) using the first discrimination function D:
d_{f,i}=D(b_{f,i},avg), d_{r,i}=D(V(b_{r,i}),avg) (14)

Here, avg may be the mean of feature vectors of all face images stored in the prototype face image DB 210.

The generation of the first discrimination function D through LDA will now be described in greater detail.

An LDA operation may be performed on a face image whose view has been transformed so that the volume of objects belonging to different classes can be maximized with the volume of objects belonging to the same class being minimized. The first discrimination function D that satisfies Equation (15), i.e., Uₒₚₜ, may be obtained as follows:

$${U}_{opt} = arg {max}_{U} \vert {U}^{T} BU \vert / \vert {U}^{T} WU \vert \qquad ( 15 )$$

Here, B may be a between-class scatter matrix for a vector b, and W may be a within-class scatter matrix for the vector b.

The above Equation (14) may be rearranged into the below Equation (16), using Uₒₚₜ of Equation (15).
d_{f,i}=U·(b_{f,i}−avg), d_{r,i}=U·(LM·b_{r,i}−avg) (16)

Final face recognition, authentication, and retrieval may be based on a result of performing a nearest neighbor matching operation on feature vectors d, i.e., the frontal view determining feature vector d_{f,i} and the rotated view determining feature vector d_{r,i}. Therefore, the first confidence generated by the first discrimination unit 270 may be defined by the below Equation (17):
∥d_{f,i}−d_{r,i}∥ (17)

Referring to FIG. 2, the first face identification unit 110 may combine the subspace transformation function Sᵥ, generated through PCA, the view transformation function D, generated using a linear matrix, and the first discrimination function D, generated through LDA, together using a piecewise linear combination method, for example. As described above, computational learning for projecting vectors of a frontal face image and vectors of a rotated face image onto a subspace, transforming of the view of the vectors of the rotated face image into a frontal view, and the generating of the first confidence between the frontal face image and the rotated face image may be performed independently of one another, thereby enhancing the precision of face identification and reducing computation costs.

PCA and LDA, e.g., as performed by the first face identification unit 110, have been discussed by Peter N. Belhumeur, Joao P. Hespanha, and David J. Kriegman in “Eigenfaces vs. Fisherfaces: Recognition Using Class Specific Linear Projection,” IEEE Trans. on Pattern Analysis and Machine Intelligence, Vol. 19, No. 7, pp. 711-720, July 1997. The linear matrix LM has been discussed by T. Vetter and T. Poggio in “Linear Object Classes and Image Synthesis from a Single Example Image,” IEEE Trans. on Pattern Analysis and Machine Intelligence, Vol. 19, No. 7, pp. 733-742, 1997.

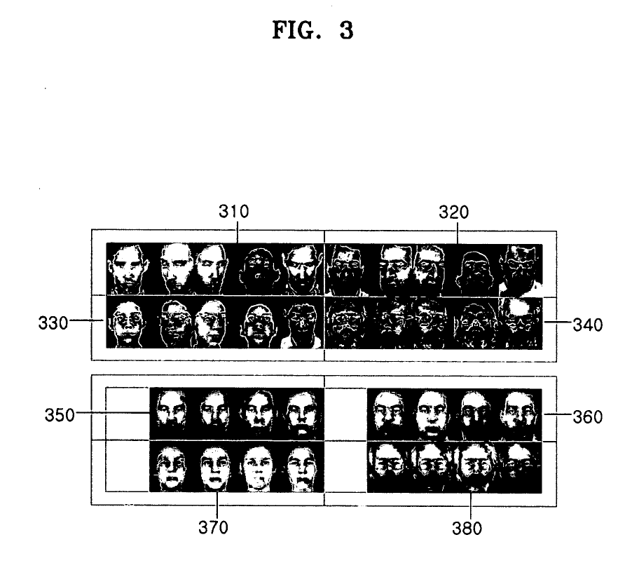

FIG. 3 illustrates results of view transformation performed by a first view transformation unit, such as that of the first view transformation unit 260. Referring to FIG. 3, according to an embodiment of the present invention, reference numerals 310, 320, 330, and 340 represent first, second, third, and fourth sets of prototype face images, respectively, and reference numerals 350, 360, 370, and 380 represent results of view-transforming the first, second, third, and fourth sets of prototype face images, respectively, by using the view transformation function V.

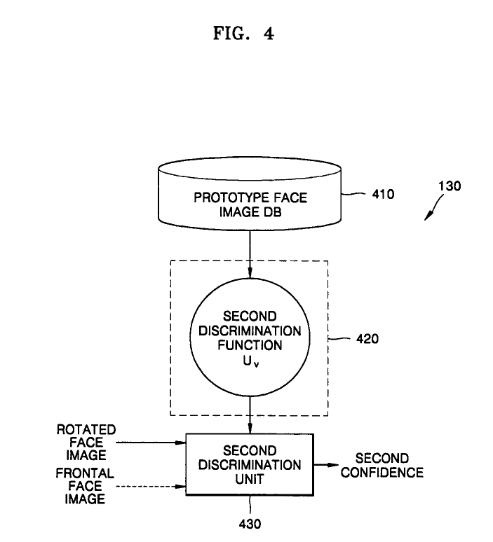

FIG. 4 illustrates a second face identification unit, such as that of the second face identification unit 130 of FIG. 1. Referring to FIG. 4, the second face identification unit 130 may include a prototype face image DB 410, a training unit 420, and a second discrimination unit 430. As only an example, the prototype face image DB 410 may be the same as the prototype face image DB 210 of FIG. 2.

The training unit 420 may generate a second discrimination function Uᵥ, into which subspace transformation, view transformation, and discrimination operations, e.g., by computational learning based on LLDA, are integrated. According to LLDA, local linear functions, such as a subspace transformation function, a view transformation function, and a discrimination function, may be simultaneously searched for each local group. Each of the local linear functions may be dependent on face images within a predetermined range of the view v. Views of face images maybe transformed into a frontal view through the searched local linear functions so that a class that can minimize within-class covariance, and maximize between-class covariance, may be generated through local linear transformation. Solutions U_{f} and Uᵣ for a frontal face image and a rotated face image, which may be searched for through LLDA, may be defined as follows, corresponding to the PCA-based transformation function, LM-based transformation function, and LDA-based discrimination function used in the aforementioned first discrimination unit 110:
d_{f,i}=U_{f}(x_{f,i},avg_{f}), d_{r,i}=Uᵣ(x_{r,i},avgᵣ)
U_{f}≡D(S_{f}(•)), U_{r≡D}(V(Sᵣ(•))) (18)

Here, the solutions U_{f} and Uᵣ may be optimised for discrimination using second-order statistics.

The second discrimination unit 430 may generate the second confidence between a frontal face image and a rotated face image using the second discrimination function UV. The second confidence may be expressed using the feature vectors d_{f,i} and d_{r,i} in the following Equation (18):
∥d_{f,i}−d_{r,i}∥ (19)

The generation of the second discrimination function Uᵥ through LLDA performed by the training unit 420, will now be described in greater detail.

According to LLDA, the second face identification unit 130 may be considered to be a simplified framework of the first identification unit 110. As compared with conventional kernel discrimination-based non-linear analysis methods, such as GDA, LLDA can efficiently prevent overfitting problems and can lower computation costs. Supposing that there is a data set X having M data, i.e., x₁, x₂, . . . , x_{M}, and each of the data has N-dimensional vectors. If data points are classified into C object classes, then X={X₁, . . . , X_{c}, . . . , X_{c}}. Input vectors can be clustered into k (where k=1, . . . ,K) subsets. The subsets may then be view-specific local groups having different transformation functions from one another. Each of the data points has a posteriori probability P(k|x) and belongs to a corresponding subset. The posteriori probability P(k|x) may be determined as follows. If a data point x belongs to k*-th local group, P(k*|x)=1 and P(k|x)=0 with respect to local groups k other than k*. In addition, Uₖ=[uₖ₁,uₖ₂, . . . ,u_{kN}] where Uₖ denotes a local linear transformation matrix and k=1, . . . , K. The local linear transformation matrix Uₖ can be determined by satisfying the following Equation (20):

$$y = {\sum }_{k = 1}^{K} P ( k \text{\textbar} x ) {U}_{k}^{T} ( x - {μ}_{k} ) \qquad ( 20 )$$

Here, μₖ is a mean vector of a k-th local group. The local linear transformation matrix Uₖ may also be also determined by maximizing an objective function J of the following Equation (21):
J=log(|B1|/|W|) (21)

Here, B and W denote a between-class scatter matrix and a within-class scatter matrix, respectively, in a local-linear-transformed feature space. A solution of Equation (20) minimizes the within-class scatter of the local-linear-transformed feature space and maximizes the between-class scatter of the local-linear-transformed feature space. In the local-linear-transformed feature space, a global mean vector m is a zero mean vector, and a mean vector m_{c} of class c having M_{c} samples may be expressed by the following Equation (22):

$${m}_{c} = \frac{1}{{M}_{c}} {\sum }_{x ∈ {X}_{c}} y = {\sum }_{k = 1}^{K} {U}_{k}^{T} {m}_{c , k} \\ where \\ {m}_{c , k} = \frac{1}{{M}_{c}} {\sum }_{x ∈ {X}_{c}} P ( k \text{\textbar} x ) ( x - {μ}_{k} ) . \qquad ( 22 )$$

The between-class scatter matrix B may be expressed by the below Equation (23):

$$\begin{matrix}B = {\sum }_{c = 12}^{C} {M}_{c} ( {m}_{c} - m ) {( {m}_{c} - m )}^{T} \\ = {\sum }_{c = 1}^{C} {M}_{c} ( {\sum }_{k = 1}^{K} {U}_{k}^{T} {m}_{c , k} ) {( {\sum }_{k = 1}^{K} {U}_{k}^{T} {m}_{c , k} )}^{T} \\ = {\sum }_{k = 1}^{K} {U}_{k}^{T} {B}_{k} {U}_{k} + {\sum }_{i = 1}^{K - 1} {\sum }_{j = i + 1}^{K} {U}_{i}^{T} {B}_{ij} {{U}_{j} ( {\sum }_{i = 1}^{K - 1} {\sum }_{j = i + 1}^{K} {U}_{i}^{T} {B}_{ij} {U}_{j} )}^{T}\end{matrix} \\ where \\ {B}_{k} = {\sum }_{c = 1}^{C} {M}_{c} {m}_{c , k} {m}_{c , k}^{T} , \\ and \\ {B}_{ij} = {\sum }_{c = 1}^{C} {M}_{c} {m}_{c , i} {m}_{c , j}^{T} . \qquad ( 23 )$$

The within-class scatter matrix W may be expressed by below Equation (24):

$$\begin{matrix}W = {\sum }_{c = 1}^{C} {\sum }_{x ∈ {X}_{c}} ( y - {m}_{c} ) {( y - {m}_{c} )}^{T} \\ = {\sum }_{k = 1}^{K} {U}_{k}^{T} {W}_{k} {U}_{k} + {\sum }_{i = 1}^{K - 1} {\sum }_{j = i + 1}^{K} {U}_{i}^{T} {W}_{ij} {U}_{j} + {( {\sum }_{i = 1}^{K - 1} {\sum }_{j = 1 + 1}^{K} {U}_{i}^{T} {W}_{ij} {U}_{j} )}^{T}\end{matrix} \\ {W}_{k} = {\sum }_{c = 1}^{C} {\sum }_{x ∈ {X}_{c}} ( P ( k \text{\textbar} x ) ( x - {μ}_{k} ) - {m}_{c , k} ) {( P ( k \text{\textbar} x ) ( x - {μ}_{k} ) - {m}_{c , k} )}^{T} \\ {W}_{ij} = {\sum }_{c = 1}^{C} {\sum }_{x ∈ {X}_{c}} ( P ( i \text{\textbar} x ) ( x - {μ}_{i} ) - {m}_{c , i} ) {( P ( j \text{\textbar} x ) ( x - {μ}_{j} ) - {m}_{c , j} )}^{T} \qquad ( 24 )$$

Here, Wₖ may be a local structure and Wᵢⱼ may be an interaction term of two local frames.

LLDA, e.g., as applied to the second face identification unit 130, has been discussed by Tae-kyun Kim, Josef Kittler, Hyun-chul Kim, and Seok-cheol Kee in “Discriminant Analysis by Locally Linear Transformations,” British Machine Vision Conference, pp. 123-132, Norwich, UK, 2003.

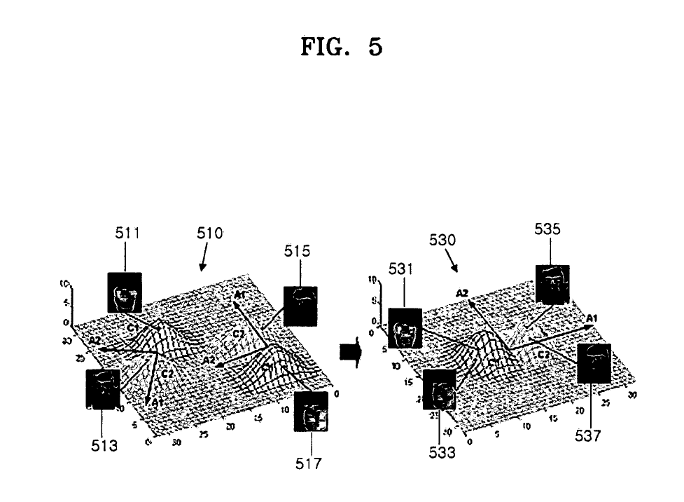

FIG. 5 illustrates an operating principle of a second face identification unit, such as the second face identification unit 130 of FIG. 4. Referring to FIG. 5, reference numeral 510 illustrates a distribution of data, including reference numerals 511, 513, 515, and 517, yet to be linear transformed and a pose group-specific linear transformation function searched for, through LLDA, according to an embodiment of the present invention. Reference numeral 530 illustrates a distribution of data linearly transformed through the searched pose-specific linear transformation function. In the case of using LLDA, face images 531 and 533 belong to the same class, i.e., class 1 (c1), but have different views from each other, and face images 535 and 537 belong to the same class, i.e., class 2 (c2), but have different views from each other.

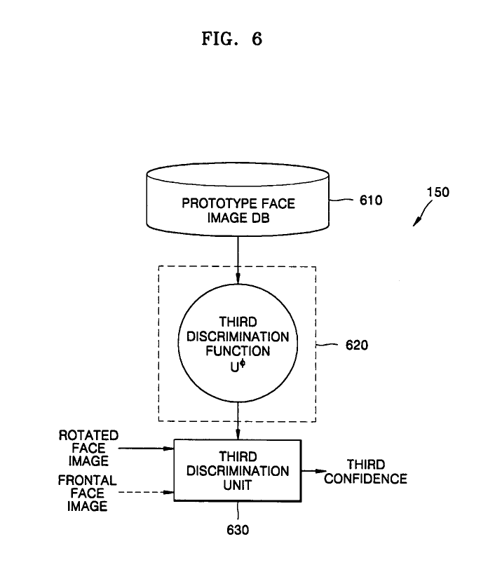

FIG. 6 illustrates a third face identification unit, such as the third face identification unit 150 of FIG. 1. Referring to FIG. 6, the third face identification unit 150 may include a prototype face image DB 610, a training unit 620, and a third discrimination unit 630. According to an embodiment of the present invention, the prototype face image DB 610 may be the same as the prototype face image DB 210 of FIG. 2.

The third discrimination unit 630 may transform a space of an input face image into a high-dimensional feature space through GDA based on a kernel function Φ, and linearly separate the transformation results. The first and second face identification units 110 and 130 apply different linear functions to face images having different views. However, the third face identification unit 150 may apply a third discrimination function U^{Φ}, which is a non-linear transformation function, to all of the face images having different views. The third discrimination function U^{Φ} may be expressed by the following Equation (25):
d_{f,i}=U^{Φ}(Φ(x_{f,i},avg)), d_{r,i}=U^{Φ}(Φ(x_{r,i},avg)) (25)

By using the feature vectors d_{f,i} and d_{r,i} of Equation (25), the third confidence between the frontal face image and the rotated face image may be expressed by the following Equation (26):
∥d_{f,i}−d_{r,i}∥ (26)

The generation of the third discrimination function U^{Φ}, e.g., through GDA performed by the training unit 620, will now be described in greater detail.

GDA is designed for non-linear separation based on the kernel function Φ. X→Z that transforms an input space X into a high-dimensional feature space Z. GDA can be applied to a set of training face images in the prototype face image DB 610 and generate a non-linear subspace, robust even against new classes. A between-class scatter matrix B^{Φ} and a within-class scatter matrix W^{Φ} of non-linearly mapped data may be expressed by the following Equation (27):

$${B}^{Φ} = \frac{1}{M} {\sum }_{c = 1}^{C} {M}_{c} {{m}_{c}^{Φ} ( {m}_{c}^{Φ} )}^{T} \\ {W}^{Φ} = \frac{1}{M} {\sum }_{c = 1}^{C} {\sum }_{x ∈ {X}_{c}} Φ ( x ) {Φ ( x )}^{T} \qquad ( 27 )$$

Here, X_{c} may be a data set of class c, M may be a total number of samples, m_{c}^{Φ} may be a mean of class c in the high-dimensional feature space Z, and M_{c} may be a total number of samples of the data set X_{c}. The third discrimination function U^{Φ} that satisfies Equation (28) below, i.e., Uₒₚₜ^{Φ}, may be obtained through GDA.

$${U}_{opt}^{Φ} = arg max \frac{\vert {( {U}^{Φ} )}^{T} {B}^{Φ} {U}^{Φ} \vert}{\vert {( {U}^{Φ} )}^{T} {W}^{Φ} {U}^{Φ} \vert} = [ {u}_{1}^{Φ} , … , {u}_{N}^{Φ} ] \qquad ( 28 )$$

A vector uΦ(εZ) may be obtained as a solution of the following equation: B^{Φ}uᵢ^{Φ}=λᵢW^{Φ}uᵢ^{Φ}. According to the reproduction kernel theory focusing on a zero mean and a unit variance, the arbitrary solution u^{Φ} should be within the span of all training vectors in the high-dimensional feature space Z. In other words, the arbitrary solution u^{Φ} should satisfy the following Equation (29):

$${u}^{Φ} = {\sum }_{c = 1}^{C} {\sum }_{i = 1}^{{M}_{c}} {α}_{c , i} Φ ( {x}_{c , i} ) \qquad ( 29 )$$

Here, α_{c,i} may be a real number weight and x_{c,i} may be an i-th sample of class c. A solution of Equation (29) is obtained using the following Equation (30):

$$λ = \frac{{α}^{T} KDK α}{{α}^{T} KK α} \qquad ( 30 )$$

Here, a may be a vector satisfying the following equation: α=α_{c}, c=1, . . . , C, α_{c}=α_{c,i}, and i=1, . . . , M_{c}. A kernel matrix K, which may be an M×M matrix, may include dot products of the nonlinearly mapped data. The Kernel matrix K may be expressed by the following Equation (31):
K=(K_{k,i}), k=1, . . . ,C, l=1, . . . ,C (31)
where K_{k,l}=(k(x_{k,l},x_{i,j})) (i=1, . . . , Mₖ, j=1, . . . , Mₗ).

A block diagonal matrix D, which may be an M×M matrix, may be expressed by the following Equation (32):
D=(D_{c}) c=1, . . . ,C (32)

Here, D_{c} may be a c-th matrix on a diagonal line whose elements all have a value of

$$\frac{1}{{M}_{c}} .$$

A coefficient vector that defines the projection vector u^{Φ} (εZ) may be obtained by solving the following equation: B^{Φ}uᵢ^{Φ}=λᵢW^{Φ}uᵢ^{Φ}. Projection of a test vector xₜₑₛₜ can be obtained using the following Equation (33):

$${( {U}^{Φ} )}^{T} Φ ( {x}_{test} ) = {\sum }_{c = 1}^{C} {\sum }_{i = 1}^{{M}_{c}} {α}_{c , i} k ( {x}_{c , i} , {x}_{test} ) \qquad ( 33 )$$

GDA, e.g., as applied to the third face identification unit 150, has been discussed by G. Baudat and F. Anouar in “Generalized Discriminant Analysis Using a Kernel Approach,” Neural Computation, Vol. 12, pp. 2385-2404, 2000.

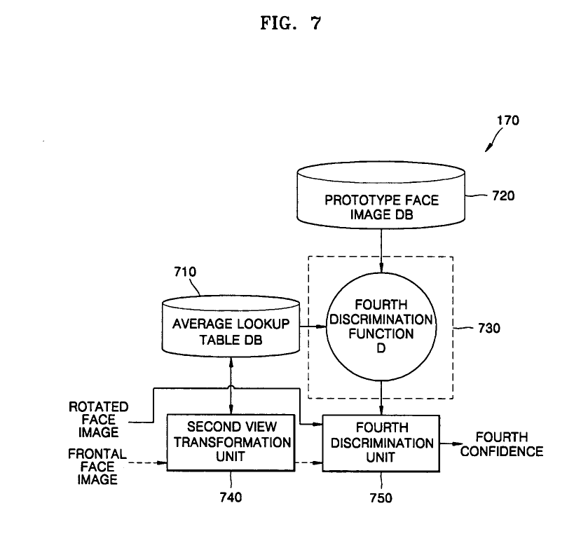

FIG. 7 illustrates a fourth face identification unit, such as the fourth face identification unit 170 of FIG. 1. Referring to FIG. 7, the fourth face identification unit 170 may include an average lookup table DB 710, a prototype face image DB 720, a training unit 730, a second view transformation unit 740, and a fourth discrimination unit 750. According to an embodiment of the present invention, the prototype face image DB 720 may be the same as the prototype face image DB 210 of FIG. 2.

The average lookup table DB 710 may be a DB of coordinate values for each view group used for transforming the view of a frontal face image to be the same as a view of a rotated face image.

The training unit 730 may generate a fourth discrimination function D by performing computational learning based on LDA on training face images stored in the prototype face image DB 720, for example.

The second view transformation unit 740 may receive vectors of a frontal face image and transform the view of the frontal face image into a view of a rotated face image by referencing the average lookup table DB 710. Texture mapping, three-dimensional rotation, and graphic rendering operations may be replaced with direct image transformation based on the average lookup table DB 710, for example. Accordingly, it is possible to achieve fast view transformation using the average lookup table DB 710.

The fourth discrimination unit 750 may defines a feature vector d_{f,i} corresponding to the view-transformed frontal face image l_{f,i} and a feature vector d_{r,i} corresponding to the rotated face image x_{r,i} using the fourth discrimination function D. The feature vectors d_{f,i} and d_{r,i} may be expressed by the following Equation (34):
d_{f,i}=U·(I_{r,i}−avg), d_{r,i}=U·(x_{r,i}−avg) (34)

The fourth discrimination unit 750 may determine the fourth confidence between the view-transformed frontal face image l_{f,i} and the rotated face image x_{r,i} as a difference between feature vectors of Equation (34), as follows in Equation 35:
∥d_{f,i}−d_{r,i}∥ (35)

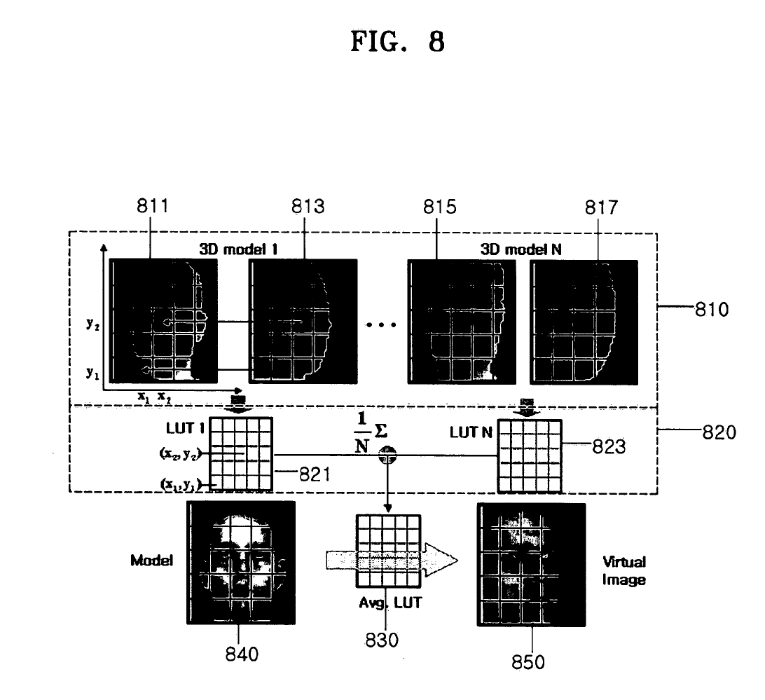

FIG. 8 illustrates the generating of an average lookup table DB, such as the average lookup table DB 710 of FIG. 7. The generating of the average lookup table DB 710 may be based on the fact that once two-dimensional color texture images are mapped onto three-dimensional face models, it is possible to synthesize any two-dimensional face images having arbitrary views based on the mapping results. Referring to FIG. 8, a three-dimensional model DB 810 may include respective first and N-th frontal face image 811 and 815 and respective rotated versions of the first and N-th face images 811 and 815, i.e., first and N-th rotated face images 813 and 817, which are all two-dimensional face images obtained by mapping color texture images onto N three-dimensional face models, view-transforming the mapping results to have a frontal view and a predetermined rotated view, and projecting the view transformation results onto a predetermined plane. Coordinates of first correspondence points between the first frontal face image 811 and the first rotated face image 813 may be generated through a first lookup table (LUT1) 821, and coordinates of N-th correspondence points between the N-th frontal face image 815 and the N-th rotated face image 817 may be generated through an N-th lookup table (LUTN) 823.

An average lookup table 830, corresponding to the view v, may be obtained by averaging coordinates of each correspondence point in a look up table group 820, corresponding to the view v. In other words, different sets of training face images corresponding to different views may have different average lookup tables.

Specifically, each element (x, y) of each of the first and N-th lookup tables 821 and 823 of an image size has a two-dimensional coordinate and represents a dense correspondence point between two face images having a different view, respectively. A lookup table LUTi(x, y) for an i-th three-dimensional face model may be approximated by the following Equation (36):
( x̅, y̅)=LUTᵢ(x, y)=P_{f}(Rot(Pᵣ⁻¹(x, y)); scale, Δx, Δy (36)

Here, P is a function that maps a three-dimensional face model onto a two-dimensional plane and has a scale and movement parameters generating face images having fixed eye positions, and Rot is a rotation function of a three-dimensional object. Coordinates of each element (x, y) of the average lookup table 830 may be represented using the following Equation (37):

$$\overline{LUT} ( x , y ) = \frac{1}{N} {\sum }_{i = 1}^{N} {LUT}_{i} ( x , y ) \qquad ( 37 )$$

A rotated face image 850 may be virtually generated from a frontal face image 840 by using the average lookup table 830. Brightness lr(x, y) of a pixel of the rotated face image 850 may be obtained from brightness lf(x, y) of a pixel of the frontal face image 840 by using the following equation: Iᵣ(x, y)=I_{f}( L̅U̅T̅(x, y)).

In short, by using the average lookup table 830, it is possible to successfully generate the rotated face image 850, having an arbitrary view, from the frontal face image 850 while maintaining most of the pixel information of the frontal face image 850.

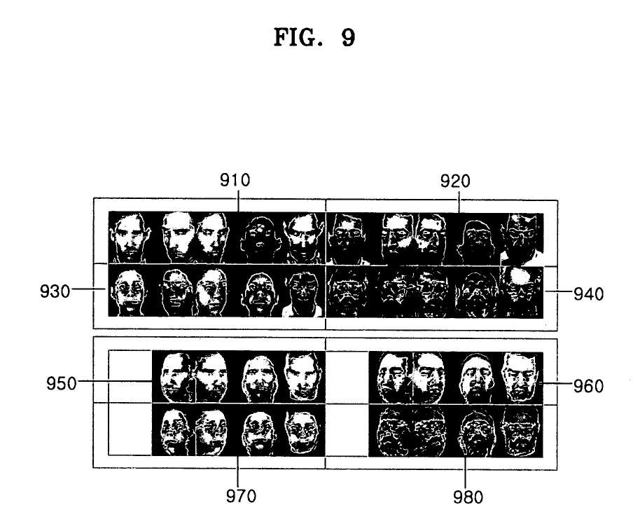

FIG. 9 illustrating various results of a view transformation operation performed by a second view transformation unit, such as the second view transformation unit 740 of FIG. 7. Referring to FIG. 9, reference numerals 910, 920, 930, and 940 may correspond to first, second, third, and fourth sets of prototype face images, respectively, and reference numerals 950, 960, 970, and 980 may correspond results of view-transforming the first, second, third, and fourth sets of prototype face images, respectively, into non-frontal face images having rotated views by using the average lookup table DB 710 of FIG. 7.

The first, second, and third face identification units 110, 130, and 150 may operate based on statistical computational learning from two-dimensional face images, and the fourth face identification unit 170 may operate based on statistical computational learning from three-dimensional face models and two-dimensional face images. The first and fourth face identification units 110 and 170 may generate a virtual face image having an arbitrary view through view transformation and may use the virtual face image for face identification. The second and third face identification units 130 and 150 may render face images using feature vectors so that the rendered face images are robust against view transformation. Thus, any of the first, second, third, and fourth face identification units 110, 130, 150, and 170 may guarantee face recognition with higher precision than conventional PCA or LDA-based face identification units. Obviously, two or more of the first, second, third, and fourth face identification units 110, 130, 150, and 170 may considerably improve the precision of face recognition.

Face identification algorithms, according to embodiments of the present invention, were implemented by the inventor, resulting in the following findings. According to an embodiment of the present invention, various transformation functions were computationally learned from the face identification algorithms using a set of training face images. The various transformation functions were applied to a new class of face images, i.e., a test set of face images. Among the test set of face images, frontal face images were used as gallery images, and rotated face images were used as query images. An XM2VTS DB, which includes face images with various pose group labels attached thereto, was further used. It will be assumed that views of the face images were precisely determined. Specifically, the XM2VTS DB included 2,950 face images obtained by taking 295 people's face images in 5 different poses over two sessions S1 and S2 that were 5 months apart from each other. The 2,950 face images were divided into 5 pose groups, i.e., a frontal view group F, two ±30° horizontally rotated view groups R and L, and two ±20° vertically rotated view groups U and D. Each of the 5 pose groups of face images may not have had the same view due to unexpected errors, but may be within a predetermined view range. The 2,950 face images had fixed eye positions and were normalized to have a 46×56 resolution. Data samples included 5 pairs of face images respectively labeled with F1, R1, L1, U1, and D1 and 5 pairs of face images respectively labeled with F2, R2, L2, U2, and D2, as shown in FIG. 1A.

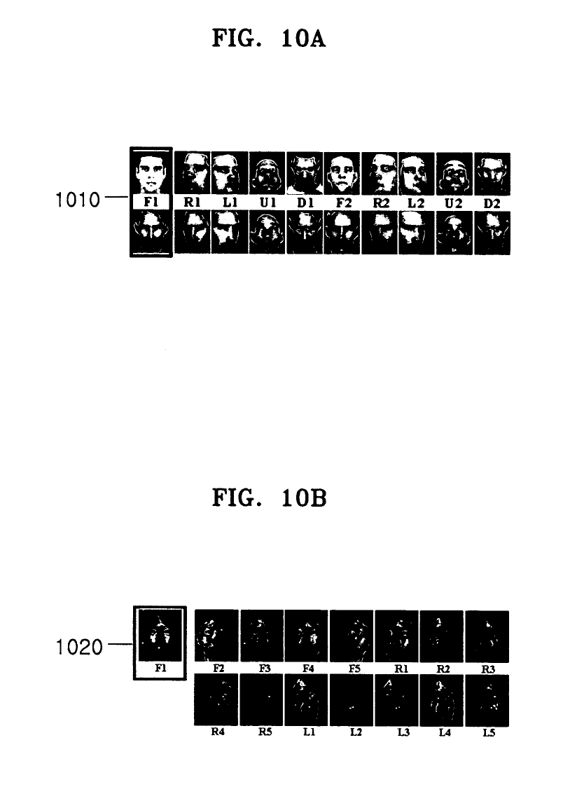

Thus, 125 people's 1,250 face images, 45 people's 450 face images, and 125 people's 1,250 face images were used as training face images, evaluation face images, and test face images, respectively. Further, classes of the training face images, classes of the evaluation face images, classes of the test face images were different from one another. The training face images were used for obtaining transformation functions, used in the first, second, third, and fourth face identification units 110, 130, 150, and 170, the evaluation face images were used for adjusting kernel parameters for GDA and parameters, used in the first, second, third, and fourth face identification units 110, 130, 150, and 170, such as dimensions of vectors output from the first, second, third and fourth face identification units 110, 130, 150, and 170 and a scaling parameter. Identification performance was obtained by using face identification rates for the test face images. A PIE data set included 15 face images (3 poses×5 illumination modes) of each of 66 people, which were evenly divided into two sets, i.e., a set of training face images and a set of test face images. Data samples included face images respectively labeled with F1 through F5, R1 through R5, and L1 through L5, as shown in FIG. 10B. Referring to FIG. 10B, the face image (1020) labeled with F1 was selected as a gallery image, and the other face images respectively labeled with F2 through F5, R1 through R5, and L1 through L5 were used as query images.

Accordingly, a performance of each of the first, second, third, and fourth face identification units 110, 130, 150, and 170 is as follows. The performance of each of the first, second, third, and fourth face identification units 110, 130, 150, and 170 was tested using the XM2VTS DB. The performance of the fourth identification unit 170, which uses the average lookup table DB 710, was tested using 108 3D-scanned face models. The performance of the third face identification unit 150, which uses GDA, was tested using a radial basis function (RBF) kernel with an adjustable width. The first and fourth face identification units 110 and 170 may be identical in terms of generating virtual rotated face images through view transformation. However, the first and fourth face identification units 110 and 170 have different view transformation characteristics from each other, as shown in FIGS. 3 and 9.

The second and third face identification units 130 and 150 render rotated face images that are very similar to their respective frontal counterparts. In other words, the second and third face identification units 130 and 150 generate similar feature vectors for face images of the same kind irrespective of views so that the face identification robust against view variations can be achieved.

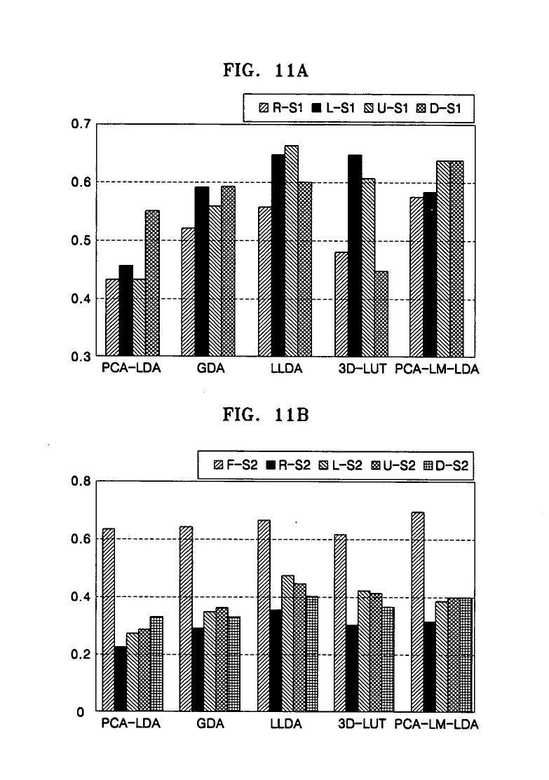

FIGS. 11A and 11B are graphs comparing face recognition rates of the first, second, third, and fourth face identification units 110, 130, 150, and 170. Specifically, FIG. 11A illustrates face recognition rates of the first, second, third, and fourth face identification units 110, 130, 150, and 170 when dealing with face images taken in the first session S1, and FIG. 11B illustrates face recognition rates of the first, second, third and fourth face identification units 110, 130, 150, and 170 when dealing with face images taken in the second session S2. Referring to FIGS. 11A and 11B, PCA-LM-LDA, LLDA, GDA, and 3D-LUT represent the first, second, third and fourth identification units 110, 130, 150, and 170, respectively. The first, second, third, and fourth face identification units 110, 130, 150, and 170 achieve higher face recognition rates than a conventional LDA-based face identification unit. In this experiment, of the first, second, third, and fourth face identification units 110, 130, 150, and 170, the second face identification unit 130 achieves the highest face recognition rates.

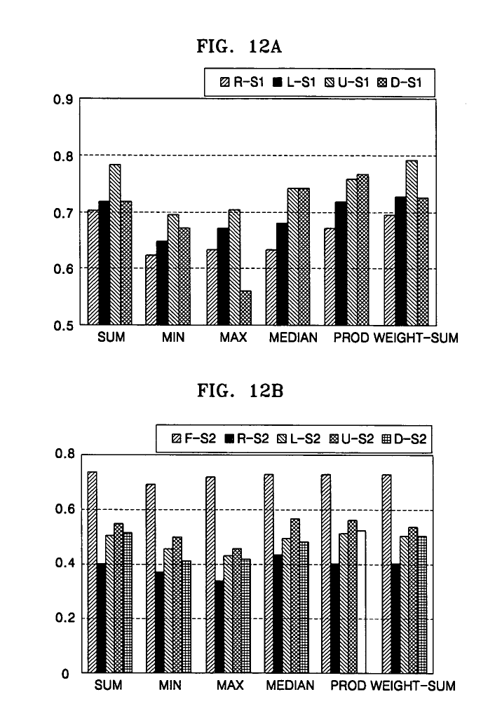

FIGS. 12A and 12B are graphs illustrating comparing face recognition rates obtained using various combination methods, such as summation (sum), minimum selection (min), maximum selection (max), median selection (median), product (prod), and weighted summation (weight-sum), to deal with frontal and rotated face images. Specifically, FIG. 12A illustrates face recognition rates obtained using the various combination methods to deal with the face images taken in the first session S1 through the various combination methods, and FIG. 12B illustrates face recognition rates obtained using the various combination methods to deal with the face images taken in the second session S2. Referring to FIGS. 12A and 12B, the face recognition rate is generally much higher when using all of the first, second, third, and fourth face identification units 110, 130, 150, and 170, using any of the various combination methods, than when using only one of the first, second, third, and fourth face identification units 110, 130, 150, and 170.

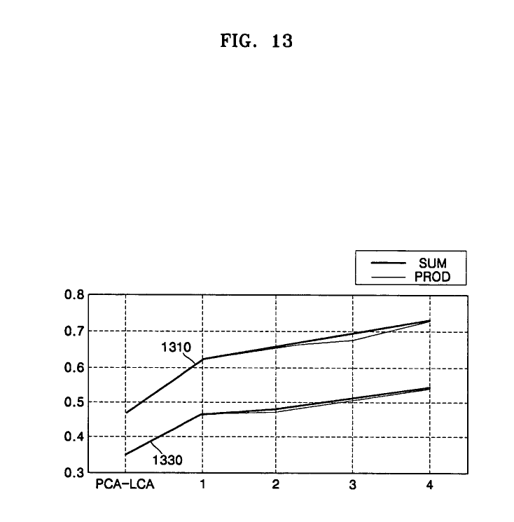

FIG. 13 illustrates a comparison of face recognition rates using different numbers of face identification units. Referring to FIG. 13, a first graph 1310 shows the variation of the face recognition rate obtained when dealing with frontal and rotated face images taken in the first session S1, and a second graph 1330 shows the variation of the face recognition rate obtained when dealing with frontal and rotated face images taken in the second session S2. As shown in FIG. 13, there is a gap between the first and second graphs 1310 and 1330, and whether a product operation or addition operation is used does not seem to considerably affect face recognition rate, in this experiment. Here, the face recognition rate is higher when using two of the first, second, third, and fourth face identification units 110, 130, 150, and 170 than when using only one of the first, second, third, and fourth face identification units 110, 130, 150, and 170, and is higher when using three of the first, second, third, and fourth face identification units 110, 130, 150, and 170 than when using only two of the first, second, third, and fourth face identification units 110, 130, 150, and 170, and is still higher when using all of the first, second, third, and fourth face identification units 110, 130, 150, and 170 than when using only three of the first, second, third, and fourth face identification units 110, 130, 150, and 170. In short, as the number of face identification units used increases, the face recognition capability of the face identification apparatus of FIG. 1 also increases.

Embodiments of the present invention may also be implemented by computer readable code on at least one medium, e.g., a computer readable recording medium, for use on one or more computers. The medium may be any data storage device that can store/transfer data which can be thereafter read/implemented by a computer system. Examples of the medium include read-only memory (ROM), random-access memory (RAM), CD-ROMs, magnetic tapes, floppy disks, optical data storage devices, and carrier waves (such as data transmission through the Internet). The medium may also be distributed over network coupled computer systems so that the computer readable code is stored/transferred and implemented in a distributed fashion. Based on the disclosure herein, programs, codes, and code segments for accomplishing embodiments of the present invention can be easily construed by programmers skilled in the art to which the present invention pertains.

As described above, according to embodiments of the present invention, it is possible to considerably enhance face identification rates regardless of whether input face images that are subjected to face recognition, face authentication, or face retrieval have a frontal view or rotated view by combining confidences provided by at least two independent face identification units.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A face identification apparatus, comprising:
a plurality of independent face identification units, with each of the face identification units generating a confidence based on a similarity between a rotated face image and a frontal face image; and
a confidence combination unit to combine confidences generated by the plurality of face identification units.

2. The face identification apparatus of claim 1, wherein the plurality of face identification units comprise:
a first face identification unit, to transform a view of the rotated face image into a frontal image view, and to calculate a first confidence between feature vectors of the frontal face image and feature vectors of the view-transformed rotated face image corresponding to the frontal image view; and
a second face identification unit to obtain feature vectors of the rotated face image and feature vectors of the frontal face image using a view-specific local linear transformation function and to calculate a second confidence between the linear transformation function obtained feature vectors of the rotated face image and the linear transformation function obtained feature vectors of the frontal face image.

3. The face identification apparatus of claim 2, wherein the first face identification unit comprises:
a subspace transformation unit to transform the rotated face image and the frontal face image on a subspace using a subspace transformation function;
a view transformation unit to transform a view of the subspace transformed rotated face image into the frontal view, using a view transformation function; and
a discrimination unit to obtain the feature vectors of the view-transformed rotated face image and the feature vectors of the frontal face image using a discrimination function to calculate the first confidence.

4. The face identification apparatus of claim 3, wherein the first face identification unit further comprises a training unit to analyze training face images to generate the subspace transformation function, the view transformation function, and the discrimination function.

5. The face identification apparatus of claim 2, wherein the second face identification unit comprises:
a training unit to analyze training face images to generate the view-specific local linear transformation function; and
a discrimination unit to obtain the obtained feature vectors of the rotated face image and the obtained feature vectors of the frontal face image using the view-specific local linear transformation function to calculate the second confidence.

6. The face identification apparatus of claim 1, wherein the plurality of face identification units further comprise:
a third face identification unit to obtain feature vectors of the rotated face image and feature vectors of the frontal face image using a kernel discrimination function and to calculate a third confidence between the kernel discrimination function based feature vectors of the rotated face image and the kernel discrimination function based feature vectors of the frontal face image.

7. The face identification apparatus of claim 6, wherein the third face identification unit comprises:
a training unit to analyze training face images to generate the kernel discrimination function; and
a discrimination unit, which obtains the kernel discrimination function based feature vectors of the rotated face image and the kernel discrimination function based feature vectors of the frontal face image, using a kernel discrimination function, to calculate the third confidence.

8. The face identification apparatus of claim 6, wherein the plurality of face identification units further comprise:
a fourth face identification unit to transform a view of the frontal face image into a rotated face image view, to obtain feature vectors of the rotated face image and feature vectors of the view-transformed frontal face image, and to calculate a fourth confidence between the fourth face identification unit obtained feature vectors of the rotated face image and the fourth face identification unit obtained feature vectors of the view-transformed frontal face image.

9. The face identification apparatus of claim 8, wherein the fourth face identification unit comprises:
an average lookup table database, which is a database of view-specific average lookup tables obtained by rotating a plurality of three-dimensional face models by a predetermined angle, generating a plurality of two-dimensional face images having a predetermined view, and averaging coordinates of correspondence points between the two-dimensional face images and the respective frontal face images;
a view transformation unit to transform the frontal face image into the rotated face image view with reference to the view-specific average lookup tables; and
a discrimination unit to obtain the fourth face identification unit obtained feature vectors of the view-transformed rotated face image and the fourth face identification unit obtained feature vectors of the frontal face image using a discrimination function to calculate the fourth confidence.

10. The face identification apparatus of claim 9, wherein the fourth face identification unit further comprises a training unit to analyze training face images with reference to the view-specific average lookup tables to generate the discrimination function.

11. The face identification apparatus of claim 2, wherein the plurality of face identification units further comprise:
a third face identification unit to transform a view of the frontal face image into a rotated face image view, to obtain feature vectors of the rotated face image and feature vectors of the view-transformed frontal face image, and to calculate a third confidence between the third face identification unit obtained feature vectors of the rotated face image and the third face identification unit obtained feature vectors of the view-transformed frontal face image.

12. The face identification apparatus of claim 1, wherein the plurality of face identification units comprise:
a first face identification unit to transform a view of the rotated face image into a frontal face image view, and to calculate a first confidence between feature vectors of the frontal face image and feature vectors of the view-transformed rotated face image corresponding to the frontal face image; and
a second face identification unit to obtain feature vectors of the rotated face image and feature vectors of the frontal face image using a kernel discrimination function and to calculate a second confidence between the kernel discrimination function based feature vectors of the rotated face image and the kernel discrimination function based feature vectors of the frontal face image.

13. The face identification apparatus of claim 12, wherein the plurality of face identification units further comprise:
a third face identification unit to transform a view of the frontal face image into a rotated face image view, to obtain feature vectors of the rotated face image and feature vectors of the view-transformed frontal face image, and to calculate a third confidence between the third face identification unit obtained feature vectors of the rotated face image and the third face identification unit obtained feature vectors of the view-transformed frontal face image.

14. The face identification apparatus of claim 1, wherein the plurality of face identification units comprise:
a first face identification unit to transform a view of the rotated face image into a frontal face image view, and to calculate a first confidence between feature vectors of the frontal face image and feature vectors of the view-transformed rotated face image corresponding to the frontal face image; and
a second face identification unit to transform a view of the frontal face image into a rotated face image view, to obtain the feature vectors of the rotated face image and feature vectors of the view-transformed frontal face image, and to calculate a second confidence between the obtained feature vectors of the rotated face image and the obtained feature vectors of the view-transformed frontal face image.

15. The face identification apparatus of claim 1, wherein the plurality of face identification units comprise:
a first face identification unit to obtain feature vectors of the rotated face image and feature vectors of the frontal face image using a view-specific local linear transformation function and to calculate a first confidence between the specific local linear transformation function based feature vectors of the rotated face image and the specific local linear transformation function based feature vectors of the frontal face image; and
a second face identification unit to obtain feature vectors of the rotated face image and feature vectors of the frontal face image using a kernel discrimination function and to calculate a second confidence between the kernel discrimination function based feature vectors of the rotated face image and the kernel discrimination function based feature vectors of the frontal face image.

16. The face identification apparatus of claim 15, wherein the plurality of face identification units further comprise:
a third face identification unit to transform a view of the frontal face image into a rotated face image view, to obtain feature vectors of the rotated face image and feature vectors of the view-transformed frontal face image, and to calculate a third confidence between the third face identification obtained feature vectors of the rotated face image and the third face identification obtained feature vectors of the view-transformed frontal face image.

17. The face identification apparatus of claim 1, wherein the plurality of face identification units comprise:
a first face identification unit to obtain feature vectors of the rotated face image and feature vectors of the frontal face image using a view-specific local linear transformation function and to calculate a first confidence between the local linear transformation function based feature vectors of the rotated face image and the local linear transformation function based feature vectors of the frontal face image; and
a second face identification unit to transform a view of the frontal face image into a rotated face image view, to obtain feature vectors of the rotated face image and feature vectors of the view-transformed frontal face image, and to calculate a second confidence between the second face identification unit obtained feature vectors of the rotated face image and the second face identification unit obtained feature vectors of the view-transformed frontal face image.

18. The face identification apparatus of claim 1, wherein the plurality of face identification units comprise:
a first face identification unit to obtain feature vectors of the rotated face image and feature vectors of the frontal face image using a kernel discrimination function and to calculate a first confidence between the kernel discrimination function based feature vectors of the rotated face image and the kernel discrimination function based feature vectors of the frontal face image; and
a second face identification unit to transform a view of the frontal face image into a rotated face image view, to obtain feature vectors of the rotated face image and feature vectors of the view-transformed frontal face image, and to calculate a second confidence between the second face identification unit obtained feature vectors of the rotated face image and the second face identification unit obtained feature vectors of the view-transformed frontal face image.

19. The face identification apparatus of claim 1, wherein the confidence combination unit combines the confidences generated by the plurality of face identification units using any one of an addition operation, a product operation, a maximum selection operation, a minimum selection operation, a median selection operation, and a weighted summation operation to perform the combination.

20. A face identification apparatus, comprising:
a subspace transformation unit to transform a rotated face image and a frontal face image on a subspace using a subspace transformation function;
a view transformation unit to transform a view of the subspace transformed rotated face image into a frontal view using a view transformation function; and
a discrimination unit to obtain feature vectors of the view-transformed rotated face image and feature vectors of the frontal face image using a discrimination function to calculate a confidence based on a similarity between the view-transformed rotated face image and the frontal face image.

21. A face identification apparatus of claim 20, further comprising a training unit, to analyze training face images to generate the subspace transformation function, the view transformation function, and the discrimination function.

22. A face identification apparatus, comprising:
an average lookup table database, which is a database of view-specific average lookup tables obtained by rotating a plurality of three-dimensional face models by a predetermined angle, generating a plurality of two-dimensional face images having a predetermined view, and averaging coordinates of correspondence points between the two-dimensional face images and the respective frontal face images;
a view transformation unit to transform a view of a frontal face image into a rotated face image view with reference to the view-specific average lookup tables; and
a discrimination unit to obtain feature vectors of the view-transformed rotated face image and feature vectors of the frontal face image using a discrimination function to calculate a confidence based on a similarity between the view-transformed rotated face image and the frontal face image.

23. The face identification apparatus of claim 22, further comprising a training unit to analyze training face images with reference to the view-specific average lookup tables to generate the discrimination function.

24. A face identification apparatus, comprising:
a plurality of independent face identification units, with each of the face identification units generating a confidence based on a similarity between a rotated face image and a frontal face image; and
a confidence combination unit to combine confidences generated from the plurality of face identification units,
wherein the plurality of face identification units comprise at least two face identification units among:
a first face identification unit to transform a view of the rotated face image into a frontal image view, and to calculate a first confidence between feature vectors of the frontal face image and feature vectors of the view-transformed rotated face image corresponding to the frontal view;
a second face identification unit to obtain feature vectors of the rotated face image and feature vectors of the frontal face image using a view-specific local linear transformation function and to calculate a second confidence between the local linear transformation function based feature vectors of the rotated face image and the local linear transformation function based feature vectors of the frontal face image;
a third face identification unit to obtain feature vectors of the rotated face image and feature vectors of the frontal face image using a kernel discrimination function and to calculate a third confidence between the kernel discrimination function based feature vectors of the rotated face image and the kernel discrimination function based feature vectors of the frontal face image; and
a fourth face identification unit to transform a view of the frontal face image into a rotated face image view, to obtain feature vectors of the rotated face image and feature vectors of the view-transformed frontal face image, and to calculates a fourth confidence between the fourth face identification unit obtained feature vectors of the rotated face image and the fourth face identification unit obtained feature vectors of the view-transformed frontal face image.

25. A face identification method, comprising:
transforming a view of a rotated face image into a frontal image view, and calculating a first confidence between feature vectors of a frontal face image and feature vectors of the view-transformed rotated face image;
obtaining feature vectors of the rotated face image and feature vectors of the frontal face image using a view-specific local linear transformation function and calculating a second confidence between the obtained feature vectors of the rotated face image and the obtained feature vectors of the frontal face image; and
combining at least the first and second confidences.

26. The face identification method of claim 25, wherein in the combining of the at least first and second confidences, the at least first and second confidences are combined using any one of an addition operation, a product operation, a maximum selection operation, a minimum selection operation, a median selection operation, and a weighted summation operation.

27. The face identification method of claim 25, further comprising:
obtaining feature vectors of the rotated face image and feature vectors of the frontal face image using a kernel discrimination function and calculating a third confidence between the kernel discrimination function based feature vectors of the rotated face image and the kernel discrimination function based feature vectors of the frontal face image.

28. The face identification method of claim 27, further comprising:
transforming a view of the frontal face image into a rotated face image view, obtaining feature vectors of the rotated face image and feature vectors of a view-transformed frontal face image, and calculating a fourth confidence between feature vectors of the rotated face image and the obtained feature vectors of the view-transformed frontal face image.

29. The face identification method of claim 25, further comprising:
transforming a view of the frontal face image into a rotated face image view, obtaining feature vectors of the rotated face image and feature vectors of a view-transformed frontal face image, and calculating a third confidence between feature vectors of the rotated face image and the obtained feature vectors of the view-transformed frontal face image.

30. A face identification method, comprising:
transforming a view of a rotated face image into a frontal image view, and calculating a first confidence between feature vectors of a frontal face image and feature vectors of the view-transformed rotated face image;
obtaining feature vectors of the rotated face image and feature vectors of the frontal face image using a kernel discrimination function and calculating a second confidence between the obtained feature vectors of the rotated face image and the obtained feature vectors of the frontal face image; and
combining at least the first and second confidences.

31. The face identification method of claim 30, wherein in the combining the at least first and second confidences, the at least first and second confidences are combined using any one of an addition operation, a product operation, a maximum selection operation, a minimum selection operation, a median selection operation, and a weighted summation operation.

32. The face identification method of claim 30, further comprising:
transforming a view of the frontal face image into a rotated face image view, obtaining feature vectors of the rotated face image and feature vectors of the view-transformed frontal face image, and calculating a third confidence between feature vectors of the rotated face image and the obtained feature vectors of the view-transformed frontal face image.

33. A face identification method, comprising:
transforming a view of a rotated face image into a frontal image view, and calculating a first confidence between feature vectors of a frontal face image and feature vectors of the view-transformed rotated face image;
transforming a view of the frontal face image into a rotated face image view, obtaining feature vectors of the rotated face image and feature vectors of a view-transformed frontal face image, and calculating a third confidence between obtained feature vectors of the rotated face image and the obtained feature vectors of the view-transformed frontal face image; and
combining a at least the first and second confidences.

34. The face identification method of claim 33, wherein in the combining of the at least first and second confidences, the at least first and second confidences are combined using any one of an addition operation, a product operation, a maximum selection operation, a minimum selection operation, a median selection operation, and a weighted summation operation.

35. A face identification method, comprising:
obtaining feature vectors of a rotated face image and feature vectors of a frontal face image using a view-specific local linear transformation function and calculating a first confidence between the local linear transformation function based feature vectors of the rotated face image and the local linear transformation function based feature vectors of the frontal face image;
obtaining feature vectors of the rotated face image and feature vectors of the frontal face image using a kernel discrimination function and calculating a second confidence between the kernel discrimination function based feature vectors of the rotated face image and the kernel discrimination function based feature vectors of the frontal face image; and
combining at least the first and second confidences.

36. The face identification method of claim 35, wherein in combining of the at least first and second confidences, the first and second confidences are combined using any one of an addition operation, a product operation, a maximum selection operation, a minimum selection operation, a median selection operation, and a weighted summation operation.

37. The face identification method of claim 35, further comprising:
transforming a view of the frontal face image into a rotated face image view, obtaining feature vectors of the rotated face image and feature vectors of the view-transformed frontal face image, and calculating a third confidence between feature vectors of the rotated face image and the obtained feature vectors of the view-transformed frontal face image.

38. A face identification method, comprising:
obtaining feature vectors of a rotated face image and feature vectors of a frontal face image using a view-specific local linear transformation function and calculating a first confidence between the linear transformation function based feature vectors of the rotated face image and the linear transformation function based feature vectors of the frontal face image;
transforming a view of the frontal face image into a rotated face image view, obtaining feature vectors of the rotated face image and feature vectors of the view-transformed frontal face image, and calculating a second confidence between feature vectors of the rotated face image and the obtained feature vectors of the view-transformed frontal face image; and
combining at least the first and second confidences.

39. The face identification method of claim 38, wherein in the combining of the first and second confidences, the first and second confidences are combined using any one of an addition operation, a product operation, a maximum selection operation, a minimum selection operation, a median selection operation, and a weighted summation operation.

40. A face identification method, comprising:
transforming a view of a rotated face image into a frontal image view, and calculating a first confidence between feature vectors of a frontal face image and feature vectors of the view-transformed rotated face image;
obtaining feature vectors of the rotated face image and feature vectors of the frontal face image using a view-specific local linear transformation function and calculating a second confidence between the local linear transformation function based feature vectors of the rotated face image and the local linear transformation function based feature vectors of the frontal face image;
obtaining feature vectors of the rotated face image and feature vectors of the frontal face image using a kernel discrimination function and calculating a third confidence between the a kernel discrimination function based feature vectors of the rotated face image and the a kernel discrimination function based feature vectors of the frontal face image;
transforming a view of the frontal face image into a rotated face image view, obtaining feature vectors of the rotated face image and feature vectors of the view-transformed frontal face image, and calculating a fourth confidence between feature vectors of the rotated face image and the obtained feature vectors of the view-transformed frontal face image; and
combining at least two confidences among the first, second, third, and fourth confidences.

41. A medium comprising computer readable code to implement a face identification method comprising:
transforming a view of a rotated face image into a frontal image view, and calculating a first confidence between feature vectors of a frontal face image and feature vectors of the view-transformed rotated face image;
obtaining feature vectors of the rotated face image and feature vectors of the frontal face image using a view-specific local linear transformation function and calculating a second confidence between the linear transformation function based feature vectors of the linear transformation function rotated face image and the linear transformation function based feature vectors of the frontal face image;
obtaining feature vectors of the rotated face image and feature vectors of the frontal face image using a kernel discrimination function and calculating a third confidence between the kernel discrimination function based feature vectors of the rotated face image and the kernel discrimination function based feature vectors of the frontal face image;
transforming a view of the frontal face image into a rotated face image view, obtaining feature vectors of the rotated face image and feature vectors of the view-transformed frontal face image, and calculating a fourth confidence between feature vectors of the rotated face image and the obtained feature vectors of the view-transformed frontal face image; and
combining at least two confidences among the first, second, third, and fourth confidences.
